(19) United States
(12) Patent Application Publication
(10) Pub. No.: US 2013/0054455 A1
(43) Pub. Date: Feb. 28, 2013

(54) System for Allocating and Managing Contributions to Account Categories

(71) Applicants: Carrie Anne Hanson, Charlotte, NC (US); Brad J. Kirchenbaum, Charlotte, NC (US); Kimberly B. Summerrow, Charlotte, NC (US); Christopher M. Adams, Charlotte, NC (US); Jason Typrin, Charlotte, NC (US); Erik S. Ross, Charlotte, NC (US); Jacqueline A. Corr, Charlotte, NC (US); Deshaun G. Hunter, Charlotte, NC (US); Susan S. Thomas, Gastonia, NC (US)

(72) Inventors: Carrie Anne Hanson, Charlotte, NC (US); Brad J. Kirchenbaum, Charlotte, NC (US); Kimberly B. Summerrow, Charlotte, NC (US); Christopher M. Adams, Charlotte, NC (US); Jason Typrin, Charlotte, NC (US); Erik S. Ross, Charlotte, NC (US); Jacqueline A. Corr, Charlotte, NC (US); Deshaun G. Hunter, Charlotte, NC (US); Susan S. Thomas, Gastonia, NC (US)

(73) Assignee: Bank of America Corporation, Charlotte, NC (US)

(21) Appl. No.: 13/221,166

(22) Filed: Aug. 30, 2011

(51) Int. Cl. G06Q 40/00

(52) U.S. Cl. 705/42

(57) ABSTRACT

According to some embodiments, a deposit system for receiving funds into an account held for an account beneficiary, the account being identifiable by an account number, comprises a management module, a contributor module, and an allocation module. The management module is operable to register a plurality of contributors. The contributor module is operable to receive information identifying a first contributor, determine whether the first contributor is one of the plurality of registered contributors, and if the first contributor is a registered contributor, receive, from the first contributor, a deposit of funds, the deposit comprising a first set of funds associated by the first contributor for deposit into the account without identifying the account by the account number. The allocation module operable to deposit the first set of funds into the account without informing the first contributor of the account number.

### TECHNICAL FIELD

The present disclosure relates to deposit systems and, more specifically, to a system for allocating and managing contributions to account categories.

### BACKGROUND

An estimated 25.6 million Americans are between the ages of 12-to-17 years old. These Americans, colloquially known as “teenagers,” spend billions of dollars in today's economy. Families also spend billions of dollars on teenagers. Thus, overall “teen” spending constitutes a substantial portion of today's economy. Traditional bank accounts offered by financial institutions do not accommodate the spending and savings habits of teenage account-holders. However, many financial institutions fail to understand that teenage account-holders will one day mature into adult account-holders, and therefore represent a substantial potential client-base for the financial institution.

### SUMMARY

According to some embodiments, a deposit system for receiving funds into an account held for an account beneficiary, the account being identifiable by an account number, comprises a management module, a contributor module, and an allocation module. The management module is operable to register a plurality of contributors. The contributor module is operable to receive information identifying a first contributor, determine whether the first contributor is one of the plurality of registered contributors, and if the first contributor is a registered contributor, receive, from the first contributor, a deposit of funds, the deposit comprising a first set of funds associated by the first contributor for deposit into the account without identifying the account by the account number. The allocation module operable to deposit the first set of funds into the account without informing the first contributor of the account number.

Certain embodiments of the invention may provide one or more technical advantages. A technical advantage of one embodiment may include the capability to separate account activities among several parties. A technical advantage of one embodiment may include the capability to institute control mechanisms among the several parties such that one party may limit the activities of another. A technical advantage of one embodiment may include the capability to enforce control mechanisms by separating funds into account categories and enforcing the control mechanisms against those account categories. Technical advantages of other embodiments include the ability to communicate a request for funds to a potential contributor, thereby making the process of depositing funds into an account easier and more direct. Technical advantages of still other embodiments include the ability to link an account established for a teenage account-holder to other, more sophisticated types of accounts as certain events occur. For example, as the teenager reaches certain ages, obtains a certain job status, achieves a certain level of education, etc., then a savings account that may be managed for a teenage account-holder may be linked to a checking account, a loan account, a different type of savings account, etc. In this regard, the financial institution is able to maintain a continuous and loyal relationship with the teenage account-holder through to adulthood.

Various embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its advantages, reference is now made to the following description taken in conjunction with the accompanying drawings, in which:

FIG. 1A shows an account management system according to one embodiment;

FIG. 1B shows the management module of FIG. 1A according to one example embodiment;

FIG. 2 shows a contribution interface according to one example embodiment;

FIG. 3 shows an example method for allocating deposited funds among a plurality of account categories held for an account beneficiary;

FIG. 4 shows an example method for allocating deposited funds among a plurality of account categories held for an account beneficiary;

FIG. 5 shows an example method for receiving funds into an account held for an account beneficiary;

FIG. 6 shows an example method for receiving funds into an account held for an account beneficiary;

FIG. 7 shows an example method for initiating the activation of an account; and

FIG. 8 shows a user, computer systems, and a network according to one example embodiment.

### DETAILED DESCRIPTION

It should be understood at the outset that, although example implementations of embodiments of the invention are illustrated below, the present invention may be implemented using any number of techniques, whether currently known or not. The present invention should in no way be limited to the example implementations, drawings, and techniques illustrated below. Additionally, the drawings are not necessarily drawn to scale.

An enterprise may include any individual, business, or organization. One example of an enterprise may include a financial enterprise. A financial enterprise may include any individual, business, or organization that engages in financial activities, which may include, but are not limited to, banking and investment activities such as maintaining accounts (e.g., transaction accounts, savings accounts, credit accounts, investment accounts, insurance accounts, portfolios, etc.), receiving deposits, crediting accounts, debiting accounts, extending credit to account holders, purchasing securities, providing insurance, and supervising a customer's portfolio.

A financial enterprise may provide a variety of financial products and services. Examples of financial products and services may include, but are not limited to, account services such as maintaining accounts, receiving deposits, crediting accounts, debiting accounts, extending credit, purchasing securities, providing insurance, and portfolio management.

A financial enterprise may provide financial products and services to customers. For example, a financial enterprise may maintain an account for a customer. The customer may perform a variety of activities using the account, including contributing funds to the account, withdrawing funds from the account, managing the account, and being responsible or liable for account transactions. In some circumstances, however, customers may not have the capacity or authorization to perform each of these activities. For example, a teenager may spend from an account, but the teenager's parents may be ultimately liable for the transactions. As another example, a relative of the teenager may contribute funds to the account but may not have any control over how the teenager spends the contributed funds.

Accordingly, teachings of certain embodiments recognize the capability to separate account activities among several parties. Teachings of certain embodiments also recognize the capability to institute control mechanisms among the several parties such that one party may limit the activities of another. Teachings of certain embodiments recognize the capability to enforce control mechanisms by separating funds into account categories and enforcing the control mechanisms against those account categories.

Many of the examples described herein refer to activities performed by a teenager and the teenager's parents and/or other relatives. Teachings of certain embodiments recognize, however, that some or all of these examples may apply to other relationships between parties, including, but not limited to, the relationship between employer and employee and the relationship between trustor, trustee, and beneficiary.

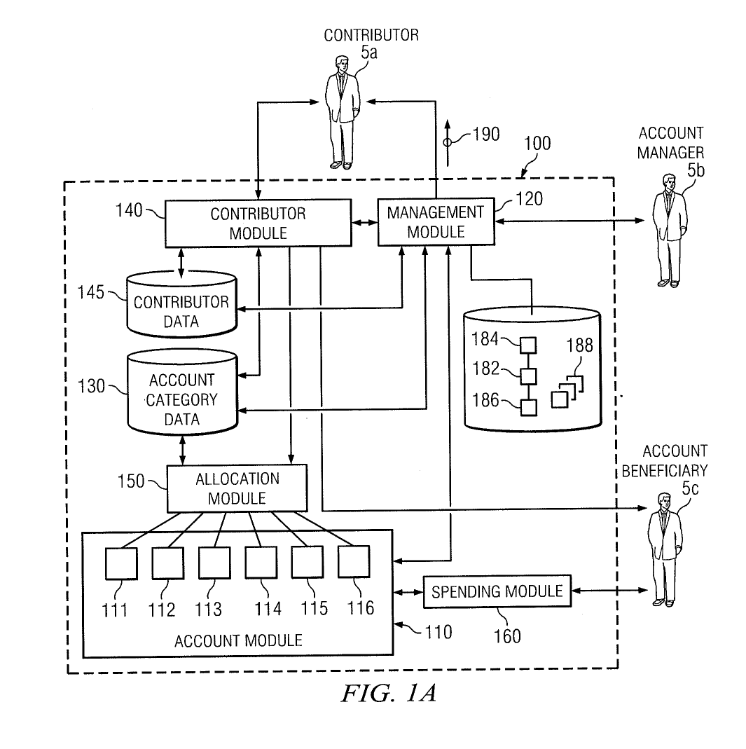

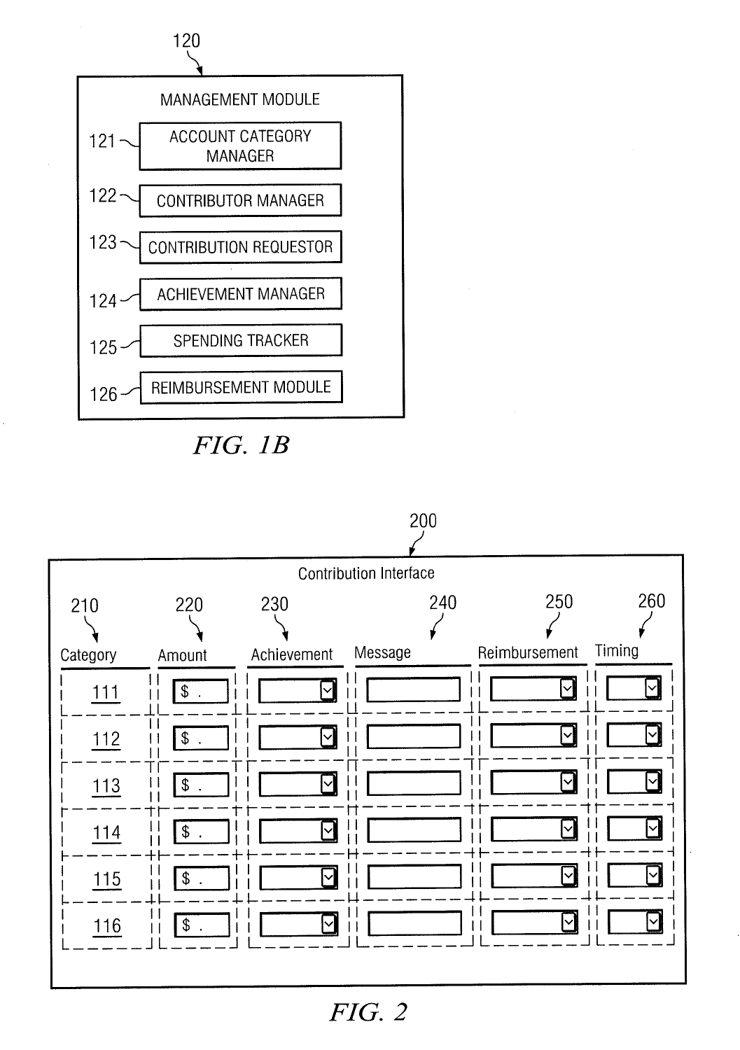

FIG. 1A shows an account management system 100 according to one embodiment. The account management system 100 of FIG. 1A features an account module 110, a management module 120, an account category data repository 130, a contributor module 140, a contributor data repository 145, an allocation module 150, and a spending module 160. FIG. 1B shows the management module 120 of FIG. 1A according to one example embodiment.

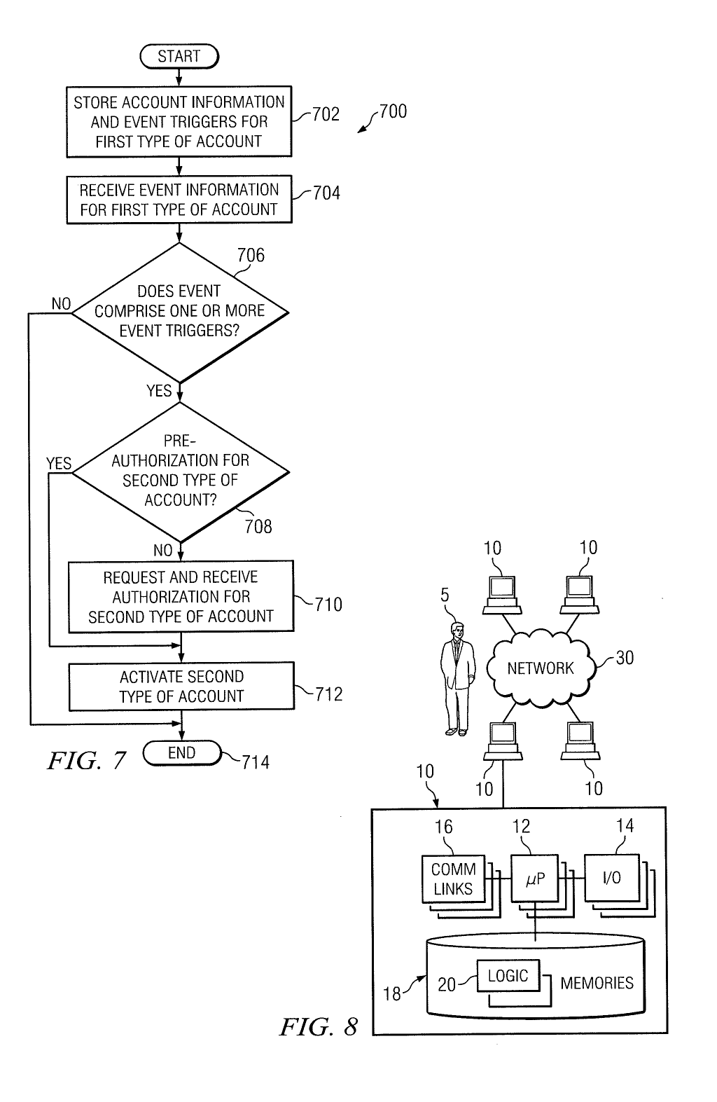

Account management system 100 may be implemented on one or more computer systems 10 and may include and/or communicate across one or more networks 30. Computer systems 10 and networks 30 are described in greater detail below with regard to FIG. 8.

Users 5 may access account management system 100 through one or more computer systems 10. In one example embodiment, a user 5 may access a computer system 10 that communicates across network 30 with a second computer system 10 that implements account management system 100. Account management system 100 may also be implemented across multiple computer systems 10, and various modules and sub-modules of account management system 100 may communicate across a network 30. In some embodiments, some modules or functions of account management system 100 may be implemented on a computer system 10 local to user 5, such as part of a web interface.

Users 5 may include any individual, group of individuals, entity, machine, and/or mechanism that interacts with computer systems 10. Users 5 are described in greater detail below with regard to FIG. 8. The example of FIG. 1A includes three example users 5: contributor 5a, account manager 5b, and account beneficiary 5c. In this example, account activities are separated among contributor 5a, account manager 5b, and account beneficiary 5c. In some embodiments, contributor 5a, account manager 5b, and account beneficiary 5c may access different modules of system 100, and each module may institute a control mechanism over another module. In the illustrated example, contributor 5a provides instructions to contributor module 140, account manager 5b provides instructions to management module 120, and account beneficiary 5c provides instructions to spending module 160. Some embodiments may include multiple users within the same category, such as multiple contributors 5a, account managers 5b, or account beneficiaries 5c.

In some embodiments, one individual may perform roles of contributor 5a, account manager 5b, and account beneficiary 5c. For example, a teenager may contribute funds to an account in the role of contributor 5a, manage certain parameters of the account in the role of account manager 5b, and spend funds from the account in the role of account beneficiary 5c. In some embodiments, each role may be divided among multiple parties. For example, responsibilities of account manager 5b may be divided among a teenager and parent. As one example, a parent may choose to transition responsibility over the account to the teenager as the teenager becomes older.

Account module 110 maintains an account having one or more account categories. Examples of an account may include, but are not limited to, a prepaid account, a checking account, a savings account, a loan account, and a credit account. An account category is a designation for funds associated with a particular purpose. Each purpose restricts the use of funds in its associated account category. For example, an account category may be designated for savings or, more particularly, for college savings or, even more particularly, for savings towards a school trip to Poland. In these examples, account beneficiary 5c may be prohibited from spending money for any non-designated purpose. Returning to the previous example, associating an account category with a particular purpose may prevent account beneficiary 5c from misappropriating the funds towards unapproved activities, such as going to the movies, renting video games, or taking a non-school trip to Cancun.

The example of FIG. 1A includes six example account categories 111-116. Account category 111 is associated with the purpose of spending for account beneficiary 5c. In this example, account beneficiary 5c is also the ultimate spender of funds and is therefore allowed to spend funds from account category 111 in any way account beneficiary 5c sees fit. Account category 112 is associated with the purpose of savings. Account category 113 is associated with the purpose of goal-oriented savings (e.g., savings towards a trip to Poland). Account category 114 is associated with investment purposes (e.g., spending in the stock market). Account category 115 is associated with college expenses (e.g., for spending at the college book store and university-approved meal plans). Account category 116 is associated with philanthropic purposes (e.g., donation to a non-profit organization). Other embodiments may include more, less, and/or different account categories than those described above.

Contributor 5a and/or account manager 5b may designate the purposes for each account category. As one example, contributor 5a may designate the purpose when contributing the funds. For example, contributor 5a may be a relative who wants the teenager to learn about investing. In this example, contributor 5a may designate the contributed funds for the purpose of investing in the stock market.

As another example, account manager 5b may configure contributor module 140 such that contributor 5a may only select from a list of available purposes. In this example, the teenager or the teenager's parent may act as account manager 5b and define the list of available purposes. Account manager 5b may also restrict the ability of contributor 5a to define new purposes. For example, the teenager may be raising money for the school trip to Poland. Even if contributor 5a does not agree with the designated purpose, contributor 5a may not, in this example, change the designated purpose of the funds.

Management module 120 provides an interface between account manager 5b and the remaining components of system 100. In the example of FIG. 1B, management module 120 features the following sub-modules: account category manager 121, contributor manager 122, contribution requestor 123, achievement manager 124, spending tracker 125, and reimbursement module 126. Sub-modules of management module 120 may be implemented together or separately and may be executed by the same processor or by different processors.

Account category manager 121 provides an interface for managing account categories. In some embodiments, account category manager 121 may allow account manager 5b to designate purposes for each account category and establish conditions under which funds may be released from each account category. For example, account manager 5b may set conditions to ensure that funds will be spent for their designated purpose. As one example, account manager 5b may require that any funds designated for college expenses be spent only at the university book store or the university cafeteria. As another example, account manager 5b may require account beneficiary 5c to seek the approval of account manager 5b before account beneficiary 5c may spend the funds. As yet another example, account manager 5b may require that all withdrawals of funds from an account category designated for lunches be under a pre-defined amount. As yet another example, account manager 5b may prohibit account beneficiary 5c from withdrawing any funds from a particular account category, such as account category 113, until the savings goal has been met.

Contributor manager 122 provides an interface for managing contributors 5a. As one example, account manager 5b may define approved contributors 5a through contributor manager 122. As another example, account manager 5b may provide information about the account categories to contributor 5a. For example, account manager 5b may instruct contributor manager 122 to inform contributor 5a of the status of account beneficiary 5c reaching a savings goal. If account beneficiary 5c is within a particular range of the target savings amount, contributor 5a may be more likely to contribute funds needed to reach the savings goal. Contribution requestor 123 provides an interface for requesting funds from contributors 5a. In one example, account beneficiary 5c may be participating in a school walk-a-thon. Account beneficiary 5c may send messages to contributors 5a through contribution requestor 123 encouraging them to contribute to account category 116. In another example, one of the contributors 5a may have agreed to reimburse certain expenses of account beneficiary 5c. In this example, account beneficiary 5b may send messages to the contributor 5a through contribution requestor 123 requesting that the contributor 5a reimburse certain expenses.

Achievement manager 124 tracks achievements accomplished by account beneficiary 5c. As will be explained in greater detail below, contributor 5a may agree to deposit funds on the condition that account beneficiary 5c accomplishes a certain achievement. In some embodiments, achievement manager 124 may automatically detect accomplishment of an achievement. For example, if contributor 5a agrees to deposit a dollar in account category 111 for every dollar account beneficiary 5c deposits into account category 113, then achievement manager 124 may initiate a transfer of funds from contributor 5a automatically when account beneficiary 5c deposits funds into account category 113.

In some embodiments, account manager 5b may inform achievement manager 124 of achievements. For example, if contributor 5a agrees to deposit a dollar in account category 116 for every mile account beneficiary 5c walks in his school's walk-a-thon, account manager 5b may inform achievement manager 124 of how many miles account beneficiary 5c walked.

Spending tracker 125 tracks withdrawals of funds by account beneficiary 5c. Account manager 5b may use spending tracker 125, for example, to audit the spending of account beneficiary 5c and confirm whether such spending is for the designated purposes. Account manager 5b may also use spending tracker 125 to identify withdrawals for reimbursement. For example, if contributor 5a agreed to reimburse account beneficiary 5c for automobile fuel costs, spending tracker 125 may communicate information to account manager 5b that identifies withdrawals for reimbursement. Alternatively, spending tracker 125 may automatically identify any transaction with a gas station and instruct contribution requestor 123 to request reimbursement.

Reimbursement module 126 manages reimbursements. For example, if spending tracker 125 identified a transaction and contribution requestor 123 requested reimbursement for the transaction, reimbursement module 126 may monitor the status of the reimbursement. If contributor 5a provides funds to reimburse account beneficiary 5c for the transaction, reimbursement module 126 may update the status to show that the reimbursement contribution has been received. Reimbursement module 126 may also direct the reimbursement payment to the account category from which the previous transaction was made. For example, if account beneficiary 5c withdrew funds from account category 111, reimbursement module 126 may direct the reimbursement payment to account category 111.

Reimbursement module 126 may identify which contributor 5a is to provide reimbursement. For example, a contributor 5a may be responsible for reimbursements of certain classification of expenses (e.g., school expenses, fuel expenses) or withdrawals from certain account categories (e.g., withdrawals from account category 115 for school expenses). In this example, reimbursement module 126 may consult contributor data 145 to determine which contributor 5a may be responsible for a reimbursement.

Account category data repository 130 stores information regarding account categories 111-116. Such information may include, but is not limited to, balance information, transaction information, purpose information, and requirements information. Requirements information may identify requirements established by account manager 5b for account category activity. For example, account manager 5b may set conditions to ensure that funds will be spent for their authorized purpose. As one example, account manager 5b may require that any funds designated for college expenses be spent only at the university book store or the university cafeteria. As another example, account manager 5b may require account beneficiary 5c to seek the approval of account manager 5b before account beneficiary 5c may spend the funds. As yet another example, account manager 5b may require that all withdrawals of funds from an account category designated for lunches be under a pre-defined amount. As yet another example, account manager 5b may prohibit account beneficiary 5c from withdrawing any funds from account category 113 until the savings goal has been met.

Contributor module 140 provides an interface between contributor 5a and the remaining components of system 100. Contributor module 140 may receive deposits from contributor 5a. A deposit may include any payment of funds or confirmation that funds may be paid in the future. In some embodiments, contributor module 140 may receive deposits without requiring contributor 5a to know any account numbers associated with account module 110 or account categories 111-116. Thus, contributor module 140 may receive deposits from contributor 5a without allowing contributor 5a to attempt subsequent withdrawals.

Contributor 5a may set a variety of parameters for each deposit. For example, contributor 5a may identify the account category or purpose of the deposit and the amount of the deposit. For example, contributor 5a may provide a first set of funds designated for a first purpose and a second set of funds designated for a second purpose. In this example, allocation module 150 may deposit the first set of funds into the account category associated with the first purpose and deposit the second set of funds into the account category associated with the second purpose.

As another example, contributor 5a may identify the achievements that must be satisfied before funds are to be released. For example, contributor 5a may provide a confirmation that funds should be deposited in at least one of the account categories upon accomplishment of an achievement by account beneficiary 5c. One example of the confirmation may include a promise to provide funds upon accomplishment of the achievement. Another example of the confirmation may include an immediate deposit of funds to be held in escrow by account management system 100 until accomplishment of the achievement. In these examples, achievement manager 124 may instruct contributor module 140 to transfer the deposited funds to the at least one of the account categories upon accomplishment of the achievement. For example, achievement manager 124 may receive notification of the accomplishment of the achievement, such as from account manager 5b, account beneficiary 5c, or another party or information source. In some circumstances, account management system 100 may provide notice of accomplishment of the achievement. For example, if contributor 5a deposits funds on the condition that account beneficiary 5c save five-hundred dollars in account category 112, then achievement manager 124 may instruct contributor module 140 to transfer the deposited funds once the balance of funds in account category 112 reaches five-hundred dollars. In some circumstances, achievement manager 124 may request confirmation of the achievement after receiving notice. For example, account beneficiary 5c may provide notice of accomplishment of an achievement, and account manager 5b may provide confirmation. Requiring confirmation of accomplishment of an achievement may prevent account beneficiary 5c from defrauding the system.

As yet another example, contributor 5a may identify an expense to be reimbursed by the deposit of funds. Spending tracker 126 may track withdrawals from account module 110, and the expense identified by contributor 5a may correspond to a withdrawal identified by spending tracker 126. In this example, spending tracker 126 may identify an account category corresponding to the withdrawal, and contributor module 140 may instruct allocation module 150 to deposit the received funds into that account category.

As yet another example, contributor 5a may identify a message to be transmitted to account beneficiary 5c. An example of a message may include a “Happy Birthday!” message to be transmitted to account beneficiary 5c along with a birthday gift to be deposited in an account category. Messages are not limited to text messages. As one example, the “Happy Birthday!” message may be accompanied with an image file or a hyperlink to an electronic greeting card.

Contributor module 140 may provide any suitable interface. For example, contributor module 140 may provide a web browser page accessible by contributor 5a. An example interface that may be provided by contributor module 140 is shown in FIG. 2, which is discussed in greater detail below.

Contributor data repository 145 stores information about contributors 5a. Contributor data repository 145 may include information provided by contributor 5a, account manager 5b, and/or other sources. For example, contributor data repository 145 may store account information provided by contributor 5a to facilitate quick transfers of funds between contributor 5a and the account categories. In another example, contributor data repository 145 may store a list of authorized contributors 5a as identified by account manager 5b. As yet another example, contributor data repository 145 may store a contribution history for each contributor 5a. This contribution history may include information regarding deposits received from contributors 5a and how each deposit was spent. As yet another example, contributor module 140 may consult contributor data repository 145 to determine wither contributor 5a is registered before allowing contributor 5a to deposit funds.

Allocation module 150 distributes deposits to the appropriate account categories 150. For example, contributor 5a may deposit $100 in account category 111 and $400 in account category 112. In this example, allocation module 150 distributes the $100 deposit to account category 111 and the $400 deposit in account category 112. In some embodiments, contributor 5a will identify a purpose for the $100 and a purpose for the $400, and allocation module 150 will consult account category data repository 130 to identify the account categories associated with the identified purposes.

Spending module 160 provides an interface between account beneficiary 5c and the remaining components of system 100. Spending module 160 may process requests from account beneficiary 5c for funds from account categories 111-116. For example, spending module 160 may receive a request for funds and information about how the funds will be spent, such as the purpose of the transaction, an amount of the transaction, or a place where the funds will be spent. Spending module 160 may compare this information with the associated purposes recorded in account category data repository 130 to determine whether the funds will be used for an authorized purpose. In some embodiments, spending module 160 may also receive information identifying a particular account category; in other embodiments, spending module 160 will compare other received transaction information with the associated purposes to determine which account categories, if any, apply to the request of account beneficiary 5c.

Account beneficiary 5c may request funds in any suitable manner. In one example embodiment, account beneficiary 5c may request a cash withdrawal or a check issuance. In this example, account beneficiary 5c may be asked to answer a variety of questions regarding the purpose of the transaction. In another example embodiment, account beneficiary 5c may have possession of a spending card linked to the account categories. In this example, account beneficiary 5c may engage in a point-of-sale transaction using the spending card, and spending module 160 may determine which account categories, if any, can fund the point-of-sale transaction. In yet another example embodiment, account beneficiary 5c may have control of other spending mechanisms and may use system 100 as a reimbursement system. For example, account beneficiary 5c may have a credit card that is outside the control of system 100, and account beneficiary 5c may use spending module 160 to request reimbursements of credit card transactions from one of the account categories 111-116.

In some embodiments, account management system 100 may allow contributor 5a to deposit funds for different purposes. For example, contributor 5a may provide a deposit of funds, some of which may be designated for a first purpose and some of which may be designated for a second purpose. In operation, according to one example embodiment, management module 120 associates account categories 111-116 with a particular purpose. These associations may be stored in account category data repository 130. Contributor module 140 may receive a deposit from contributor 5a. The deposit may include funds associated with a first purpose (e.g., spending) and funds associated with a second purpose (e.g., savings). In this example, allocation module 150 may consult account category data repository 130 to determine which account categories are associated with the first and second purposes (in this example, account categories 111 and 112). Allocation module 150 then deposit the funds associated with the first purpose in account category 111 and the funds associated with the second purpose in account category 112.

In some embodiments, account management system 100 may allow contributor 5a to deposit funds on the condition that account beneficiary 5c accomplish one or more achievements. In operation, according to one example embodiment, management module 120 associates account categories 111-116 with a particular purpose. These associations may be stored in account category data repository 130. Contributor module 140 may receive a deposit from contributor 5a. In this example, the deposit may represent confirmation from contributor 5a that contributor 5a will deposit funds in at least one of account categories 111-116 upon accomplishment of an achievement by account beneficiary 5c. In one example embodiment, the achievement may be accomplished when account beneficiary 5c deposits funds into at least one of the account categories, and the amount of funds from contributor 5a is based on the amount of funds deposited by account beneficiary 5c. For example, contributor 5a may agree to deposit a dollar for every dollar deposited by account beneficiary 5c. In another example embodiment, contributor 5a may agree to deposit a dollar into account category 111 for every dollar deposited by account beneficiary 5c into account category 112. In yet another example embodiment, the achievement is a non-financial achievement performed by the account beneficiary, such as performing chores, complete coursework, or earning certain grades in school. In some embodiments, achievement manager 124 may request confirmation of the accomplishment from a party other than account beneficiary 5c.

Achievement manager 124 may receive notification of the accomplishment of the achievement and instruct contributor module 140 to transfer the confirmed funds to the at least one of the account categories. In one example embodiment, contributor module 140 may store account information for an account associated with contributor 5a and withdraw funds from the account of contributor 5a in response to receiving the instruction to transfer the confirmed funds. In another example embodiment, contributor module 140 may store the funds in escrow and transfer the funds after receiving instructions from achievement manager 124.

In some embodiments, account management system 100 may allow contributor 5a to reimburse account beneficiary 5c for certain expenses. Account management system 100 may track withdrawals from account module 110 and seek reimbursement from contributor 5a, either automatically or based on information provided by account manager 5b and/or account beneficiary 5c. In operation, according to one embodiment, account beneficiary 5c may withdraw funds from an account category, such as account category 111. Spending tracker 125 may determine the amount of the withdrawal. Reimbursement module 126 may request that contributor 5a reimburse all or part of the amount of the withdrawal. In one example embodiment, reimbursement module 126 requests reimbursement in response to instructions received from account beneficiary 5c. If contributor 5a agrees to reimburse the withdrawal, contributor 140 may receive funds from contributor 5a, and allocation module 150 may deposit the received funds into account category 111. These instructions may also identify a particular contributor 5a from a list of potential contributors.

In some embodiments, contributor 5a may be selected from a list of registered contributors. For example, each registered contributor may be associated with at least one of the account categories, and contributor 5a may be selected because contributor 5a is associated with account category 111. This may be the case, for example, if contributor 5a previously agreed to reimburse withdrawals from account category 111. In another example, each registered contributor may be associated with a reimbursement classification, and contributor 5a may be selected because the reimbursement classification of contributor 5a corresponds to a classification of the withdrawal. For example, contributor 5a may have a reimbursement classification of “fuel expenses,” and the withdrawal by account beneficiary 5c may also be for fuel expenses. In one example embodiment, reimbursement module 126 classifies the withdrawal based on the Merchant Category Code for the withdrawal. A Merchant Category Code is a number assigned to a business. The Merchant Category Code may be used to classify the business by the type of goods or services it provides. In the “fuel expenses” example, the account beneficiary 5c may spend funds from account category 111 at a gas station, and the reimbursement module 126 may determine account beneficiary 5c spent the funds for fuel expenses based on the gas station's Merchant Category Code.

In some embodiments, account management system 100 may allow contributor 5a to provide a financial gift to account beneficiary 5c without knowing any account numbers associated with account module 110 or account categories 111-116. In operation, according to one embodiment, management module 120 registers multiple contributors 5a based on instructions received from account manager 5b. For example, account manager 5b may register a list of contributors 5a. A list of registered contributors 5a may be stored in contributor data repository 145. Contributor module 140 may be operable to receive information identifying a first contributor 5a and determine whether the first contributor 5a is a registered contributor. If the first contributor 5a is a registered contributor 5a, contributor module 140 may receive a deposit of funds from the first contributor 5a. Contributor module 140 may provide an interface to first contributor 5a that allows the first contributor 5a to deposit funds without knowing any account numbers for account beneficiary 5c. Allocation module 150 may be operable to deposit the funds without informing the first contributor 5a of any account numbers for account beneficiary 5c.

In many examples, account beneficiary 5c may wish to withdraw funds deposited by contributor 5a. In operation, according to one embodiment, account beneficiary 5c may request a withdrawal of funds from an account category, such as account category 114. Spending module 160 may receive the request and determine whether the withdrawal of funds satisfies the purpose of account category 114. For example, spending module 160 may compare the request with information from account category data repository 130 that identifies the purpose of account category 114. If the withdrawal of fund satisfies the purpose of account category 114, spending module 160 may facilitate withdrawal of the requested funds.

In a particular embodiment of system 100, the account being managed may comprise a first type of account 182 for an account-holder. For example, the first type of account 182 may be a savings account, such as a prepaid savings account, that is maintained for a child or teenager. In some embodiments, the first type of account 182 may correspond to the account maintained by account module 110.

As the child or teenage account-holder grows up, he or she may reach a level of maturity or responsibility at which the first type of account 182 may be replaced with a second type of account 188. The second type of account 188 may comprise, for example, a checking account, a credit card account, a loan account, a college savings account, or other types of accounts that are more sophisticated, or offer more privileges and functionality than a savings account.

The first type of account 182 may be associated with account information 184 and event triggers 186. Account information 184 may comprise specific details regarding account 182, such as the name and address of the account-holder, the social security number of the account-holder, information about the account-holder's parent or guardian that may serve as an account manager 5b, account balance information, account deposit information, or any other suitable data regarding account 182. Event triggers 186 may comprise different types of events associated with account 182. When one or more event triggers 186 occurs, it may signal that the account-holder is ready to shift from the first type of account 182 to a second type of account 188. Non-limiting examples of event triggers 186 comprise an age qualification, an account balance qualification, a deposit type qualification, an education qualification, and a tenure qualification. Account information 184 and event triggers 186 may be linked to account 182 and stored in memory 18.

In operation, management module 120 may receive event information associated with account 182. The event information may indicate that a particular type of event associated with account 182 has occurred. For example, the event information may indicate that the account-holder has reached a particular age (e.g., the account-holder turned sixteen years of age); that the balance associated with account 182 has reached a particular level (e.g., the account balance has reached and maintained a daily account balance average of $1500 for six straight months); that a particular type of deposit of funds is being made to the account 182 (e.g., the account-holder is directly depositing paychecks into account 182); that the account-holder has reached a particular level of education (e.g., the account-holder has graduated from high-school or college); or that the account-holder has maintained the account in good standing for a particular period of time (e.g., the account-holder has maintained the account in good standing for a period of 5 years).

Management module 120 may determine whether the event that occurred comprises one of the event triggers 186. For example, if an event trigger 186 relates to an age qualification of eighteen years old, and the account holder reaches the age of eighteen, then management module 120 may determine that an event occurred that comprises one of the event triggers 186. In another example, if an event trigger 186 relates to an education qualification of graduating high school, and the account holder recently graduated high school, then management module 120 may determine that an event occurred that comprises one of the event triggers 186.

If management module 120 determines that the event that occurred comprises one of the event triggers 186 associated with account 182, then management module 120 may initiate the activation of a second type of account 188. In a particular embodiment, a combination of two or more event triggers 186 may need occur in order for management module 120 to initiate the activation of a second type of account 188. The combination of event triggers may be determined by the financial institution, the account manager 5b, or by both in conjunction with one another. Thus, for example, if both the event triggers 186 relating to an age qualification of eighteen years old and an education qualification of graduating high school need to be met, then management module 120 will initiate the activation of the second type of account 188 upon receiving event information that the account holder has both turned eighteen years old and graduated from high school.

The initiation of the second type of account 188 is based at least in part upon the account information 184 associated with account 182 held by the account holder. In this regard, management module is able to use information such as the name, address, social security number, and/or any other account information 184 in order to automatically activate the second type of account 188. In this regard, the account holder does not need to fill out any forms or perform additional registration associated with the second account type 188.

In a particular embodiment, management module 120 may seek authorization for activating account 188 from the account manager 5b of the account 182 prior to activating the second type of account 188. This may occur by sending an electronic request to account manager 5b, and receiving an electronic acknowledgement from account manager 5b authorizing the activation of the second type of account 188. For example, the request may be sent to a parent of an account-holder by email and state, “Congratulations!! Your teenager has qualified for a checking account with our financial institution. Would you like for a checking account to be activated?” Upon receiving the authorization from the account manager 5b, management module 120 may activate second type of account 188. In another embodiment, account manager 5b may have pre-authorized the activation of one or more types of accounts 188 when the first type of account 182 was initially established. For example, a parent of an account-holder may have pre-authorized the activation of a checking account 188 upon the teenager reaching the age of eighteen. In this embodiment, management module 120 may activate second type of account 188 upon the determination of an event trigger 186, and does not need to seek additional authorization of account manager 5b at the time account 188 is opened.

The following are examples of the activation of a second type of account 188 based on the occurrence of one or more event triggers 186. In one example, if the teenage account-holder of a savings account 182 reaches the age of sixteen, management module 120 may determine that on the account-holder's sixteenth birthday, an age qualification event trigger 186 has been met and may therefore initiate the activation of a checking account 188 on behalf of the account-holder. Reaching the age of sixteen may indicate that the account-holder has reached a level of maturity and responsibility to merit the change from a savings-based account 182 to a checking-based account 188. In another example, account 182 may be established such that a combination of two or more event triggers need to occur in order for the second type of account 188 to be initiated. In his example, for instance, if the teenage account-holder of a savings account 182 reaches the age of sixteen and obtains a job whereby paychecks are directly deposited into account 182, then management module 120 may determine that upon the occurrence of these two events, an age qualification event trigger 186 and a deposit type qualification event trigger 186 have both been met and may therefore initiate the activation of a checking account 188 on behalf of the account-holder. Reaching the age of sixteen and holding a steady job may indicate that the account-holder has reached a level of maturity and responsibility to merit the change from a savings-based account 182 to a checking-based account 188. Other examples could be constructed based on any suitable number and combination of event triggers 186 being met for a particular account 182.

In these examples, management module 120 uses the account information 184, such as the name, address, social security information, account balance information, and the like to automatically initiate the activation of the second type of account 188. In this regard, the account-holder does not necessarily need to fill out forms with the financial institution that are normally associated with opening and activating an account. As described above, management module 120 may request authorization from an account manager 5b or determine that it has pre-authorization from an account manager 5b before actually activating second account type 188. In some embodiments, the first type of account 182 is converted into the second type of account 188 after it is activated. In these embodiments, the account information 184 (e.g., account balance) is simply transferred to the second type of account 188. In other embodiments, both first type of account 182 and second type of account 188 co-exist simultaneously.

In one embodiment of operation, management module 120 (e.g., contribution requestor 123) may generate and communicate a request for funds message 190 to contributor 5a. Request for funds message 190 may include a link that can be navigated by contributor 5a to a webpage where contributor 5a is presented with a request to deposit funds into account 182. The message 190 may comprise an email communication, a text message, a social networking site message, or any other suitable message 190 communicated via any suitable communication medium over any suitable communication path, such as through network 30. In a particular embodiment, the link may comprise a hyperlink that is embedded in the message 190 and, when clicked, is operable to navigate a web-browser of contributor 5a's computer system 10 to a webpage. The funds message 190 may be distributed to a subset of potential contributors 5a. For example, if the account beneficiary 5c is a teenager that is saving money for a school trip, then the message 190 may be sent to all four grandparents of the teenager with a request to donate a certain sum of money ($250) individually or in the aggregate.

In one embodiment, the webpage is affiliated with the financial institution that maintains account 182 for the account beneficiary 5c. The webpage may present any suitable combination of information that presents the request for funds in any suitable manner to contributor 5a. For example, in a particular embodiment, the webpage may present the contribution interface 200 that is described in greater detail below in FIG. 2. In this regard, the webpage may present information, such as account information 184, and information identifying an amount of a funds request, the account beneficiary 5c of the account 182, and a purpose for the funds request. The purpose for the funds request may specify whether the funds request is for a gift or a loan. If it is a gift, then the account beneficiary 5c would not need to repay the funded amount. If it is a loan, then the account beneficiary 5c would reimburse, or pay back, the funded amount according to agreed upon terms. In his regard, the requested funds can be earmarked for repayment by the account beneficiary 5c to the contributor 5a. For example, if the funds request was earmarked to purchase a guitar, then grandma might contribute $100 on the condition that the teenager repay some or all of the requested funds after earning money with a summer job. The purpose of the funds request may also specify whether the funds request is for a savings purpose or for a spending purpose. These purposes can be further categorized into types of spending (e.g., purchase a new guitar, clothes shopping, etc.) or types of savings (e.g., saving for a school trip, college savings, etc.). These and other details about the information that may be presented to contributor 5a are explained in greater detail below with reference to the contribution interface 200 illustrated in FIG. 2.

Management module 120 and/or contributor module 140 of system 100 may receive a response to the fund request indicating an outcome of the fund request. For example, the outcome may be communicated via the contribution interface 200 (or other information presented or received via the linked webpage), and indicate that contributor 5a (a) accepts the funds request and initiates the deposit of the request funds to the account, (b) partially accepts the funds request and initiates the deposit of a portion of the requested funds to the account, (c) denies the funds request completely, or (d) conditionally accepts the funds request and initiates the deposit of at least a portion of the requested funds upon the achievement of a specific goal. Example achievement goals could be based upon the completion of school coursework, a certain date, achievement of certain grades, job status, etc. In a particular embodiment, the response by the contributor 5a may modify the stated purpose of the funds request. For example, if the stated purpose of the funds request was related to spending, then the response may change that purpose from spending to saving. Or, if the stated purpose of the funds request was related to spending on a new guitar, then the response may change that purpose to spending on new clothes for school.

FIG. 2 shows a contribution interface 200 according to one example embodiment. Contribution interface 200 represents one example of an interface that may be provided by contributor module 140 to contributor 5a. In the example of FIG. 2, contribution interface 200 includes six information fields: category field 210, amount field 220, achievement field 230, message field 240, reimbursement field 250, and timing field 260.

Category field 210 identifies the account category that will receive the deposit. In the example of FIG. 2, a row is shown for each account category 111-116. In some embodiments, contribution interface 200 may not expressly refer to account categories. For example, contribution interface 200 may request that contributor 5a select a purpose, and contributor module 140 may consult account category data 130 to identify the account category corresponding to the selected purpose.

Amount field 220 identifies the amount of funds to be deposited. In one example embodiment, contributor 5a provides a fixed dollar value (e.g., fifty dollars). In another example embodiment, amount fields 220 are automatically populated to include suggested values. In another example embodiment, amount fields 220 are automatically populated based on other inputs provided by contributor 5a. For example, contributor 5a may input a deposit of $100 into account category 111; contribution interface 200 may automatically divided the $100 into a $50 deposit into account category 111 and a $50 deposit into account category 112. In some circumstances, the division between account category 111 and account category 112 may slide with age (e.g., the ratio of account category 111 to account category 112 increases as account beneficiary 5c becomes older). In some embodiments, contributor 5a is given the option to override allocations between account category 111 and account category 112. In other embodiments, account manager 5b configures contribution interface to fix the allocations between account categories. In another example, contributor 5a may not input any dollar amounts. For example, if contributor 5a agrees to match deposits by account beneficiary 5c, then amount field 220 may not include any fixed dollar amount.

Achievement field 230 identifies the achievement, if any, that account beneficiary 5c must accomplish before funds will be deposited. In one example, contributor 5a may agree to match deposits by account beneficiary 5c. In this example, contributor 5a may select a matching achievement from achievement field 230. In another example, contributor 5a may select a non-financial achievement performed by the account beneficiary, such as performing chores or earning certain grades in school. In some embodiments, multiple achievements may be identified in achievement field 230 (e.g., will match every dollar deposited in account category 112 if account beneficiary 5c also maintains good grades and deposits at least $50 per month into account category 112).

Message field 240 identifies a message, if any, that contributor 5a would like to communicate to account beneficiary 5c. An example of a message may include a “Happy Birthday!” message to be transmitted to account beneficiary 5c along with a birthday gift to be deposited in an account category. Messages are not limited to text messages. As one example, the “Happy Birthday!” message may be accompanied with an image file or a hyperlink to an electronic greeting card. In some embodiments, contributor 5a may provide a customized message in message field 240. In other embodiments, contributor 5a may select from among a list of sample messages.

Reimbursement field 250 identifies a transaction to be reimbursed, if any. In some embodiments, the transaction identified in reimbursement field 250 may correspond to a transaction identified by spending tracker 125. In some embodiments, selecting a transaction from reimbursement field 250 may allow contribution interface 200 to auto fill other fields. For example, contribution interface 200 may retrieve the amount of the transaction to be reimbursed from spending tracker 125 and insert the amount into amount field 220.

Timing field 260 identifies when the funds will be deposited. Example entries in timing field 260 may include, but are not limited to: immediately, periodically (e.g., weekly, monthly, yearly), on a certain date (e.g., birthday of account beneficiary 5c), and any combination of timing requirements (e.g., yearly on the birthday of account beneficiary 5c).

Embodiments of contribution interface 200 may include additional fields. For example, contribution interface 200 may include a source field. A source field identifies the source of income from contributor 5a (e.g., checking account of contributor 5a). In some embodiments, contributor 5a may provide an account and routing number to facilitate automatic transfers between contributor 5a and account beneficiary 5c.

In some embodiments, contribution interface 200 may provide additional fields depending on information provided by contributor 5a. For example, contributor 5a may select account category 114, which is associated with investment purposes. In this example, if contributor 5a selects account category 114 in category field 210, contributor 5a may present a new investment field. This investment field may allow contributor 5a to select certain investments or categories of investments. Contributor 5a may also select investments on behalf of account beneficiary 5c or may choose to let account beneficiary 5c select the investments.

In the example of FIG. 2, contribution interface 200 does not identify any account numbers of account beneficiary 5c. Concealing account numbers from contributor 5a may protect the accounts of account beneficiary 5c from unscrupulous behavior, such as attempting to withdraw funds or transmit account numbers to a third party. In some embodiments, contribution interface 200 may also conceal account numbers of contributor 5a. For example, if contributor 5a and account beneficiary 5c are customers of the same financial institution, the financial institution may manage the account numbers without divulging them to either party.

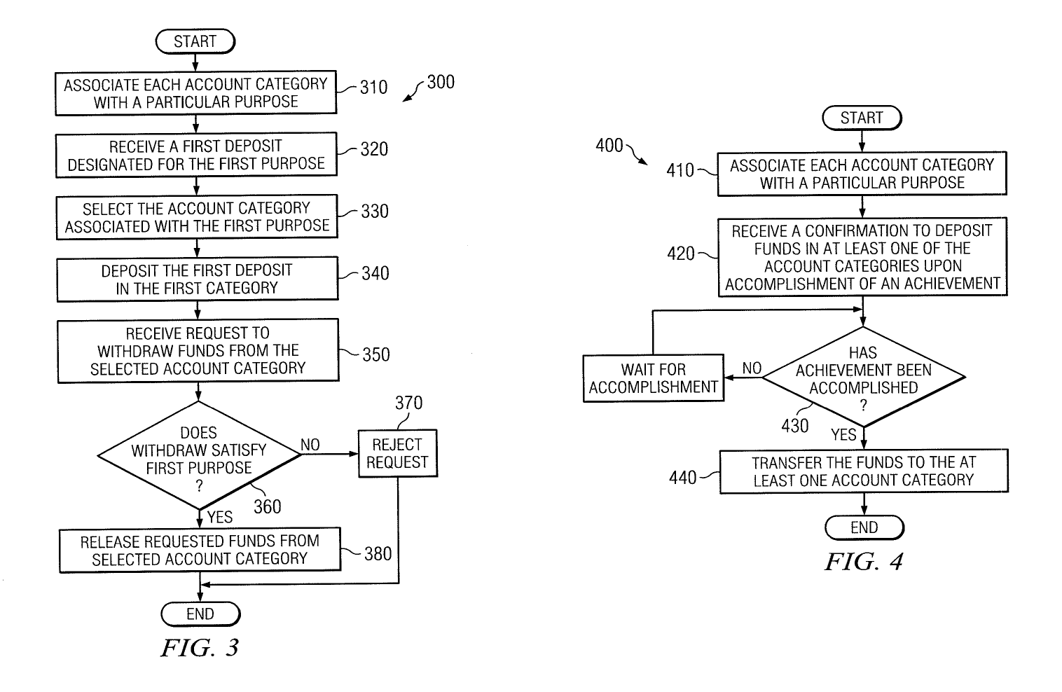

FIG. 3 shows an example method 300 for allocating deposited funds among a plurality of account categories held for an account beneficiary. At step 310, account category manager 121 associates each account category 111-116 with a particular purpose. Information identifying the particular purpose for each account category 111-116 may be stored in account category data repository 130. At step 320, contributor module 140 may receive a first deposit designated for a first purpose. At step 330, allocation module 150 selects the account category among account categories 111-116 associated with the first purpose. At step 340, allocation module 150 deposits the first deposit into the selected account category.

At step 350, spending module 160 receives a request to withdraw funds from the selected account category. At step 360, spending module 160 consults account category data repository 130 to determine whether the withdrawal satisfies the first purpose. If the withdrawal does not satisfy the first purpose, spending module 160 rejects the request at step 370. If the withdrawal does satisfy the first purpose, spending module 160 releases the requested funds from the selected account category at step 380.

FIG. 4 shows an example method for receiving funds to be deposited into an account held for an account beneficiary upon accomplishment of a certain achievement. At step 410, account category manager 121 associates each account category 111-116 with a particular purpose. Information identifying the particular purpose for each account category 111-116 may be stored in account category data repository 130. At step 420, contributor module 140 receives a confirmation to deposit funds in at least one of the account categories 111-116 upon accomplishment of an achievement. At step 430, achievement manager 124 determines whether account beneficiary 5c has achieved the accomplishment. If account beneficiary 5c has achieved the accomplishment, achievement manager 124 instructs contributor module 440 to transfer the funds to the at least one account category. If account beneficiary 5c has not achieved the accomplishment, achievement manager 124 withholds approval of the transfer of funds to the at least one account category.

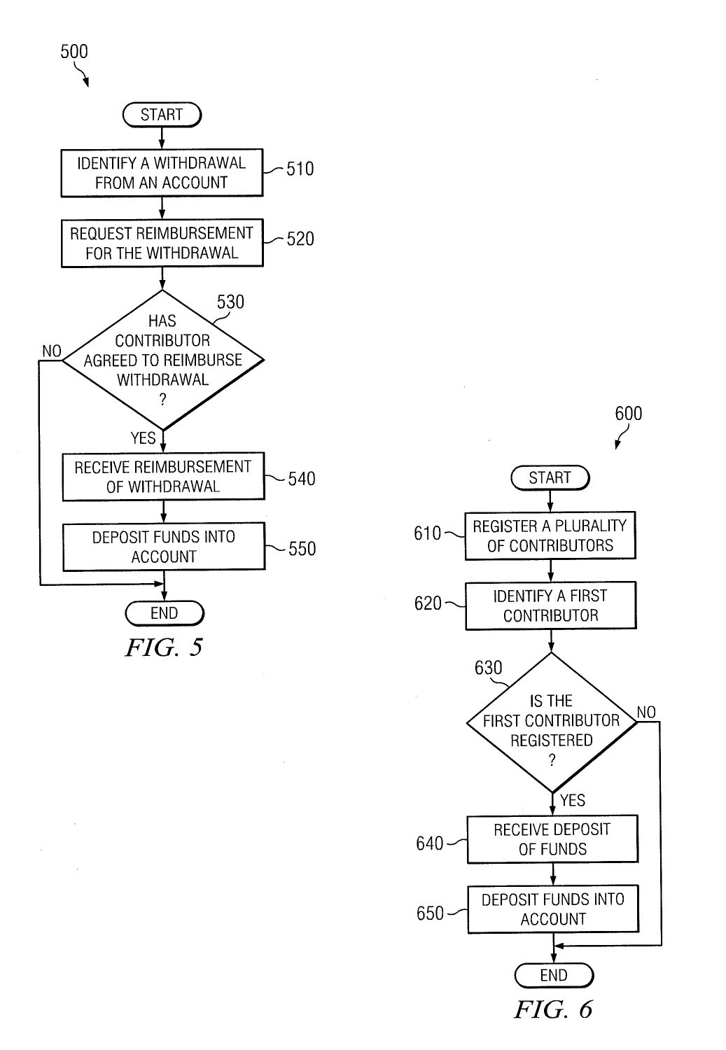

FIG. 5 shows an example method 500 for receiving reimbursements for withdrawals of funds from an account held by an account beneficiary. At step 510, spending tracker 125 identifies a withdrawal from the account of account beneficiary 5c. At step 520 spending tracker 125 requests reimbursement for the withdrawal from contributor 5a. If contributor 5a has agreed to reimburse the withdrawal at step 530, then contributor module 140 can receive reimbursement of the withdrawal from contributor 5a at step 540. At step 550, allocation module 150 deposits the reimbursement into the account.

FIG. 6 shows an example method 600 for receiving a financial gift into an account held for an account beneficiary. At step 610, contributor manager 122 registers a plurality of contributors 5a. A list of registered contributors 5a may be stored in contributor data repository 145. At step 620, contributor module 140 may identify a first contributor 5a. For example, first contributor 5a may communicate an intention to contributor module 140 to deposit funds for account beneficiary 5c. At step 630, contributor module 140 may consult contributor data 145 to determine whether the first contributor 5a is on the list of registered contributors 5a. If so, contributor module 140 can receive the deposit of funds from the first contributor 5a at step 640. At step 650, allocation module 150 deposits the funds into the account.

FIG. 7 shows an example method 700 for initiation the activation of a second type of account 188. Additional or fewer steps of method 700 may be implemented, and in any suitable order, without departing from the scope of the present disclosure. Method 700 begins at step 702 where management module 120 stores in memory account information 184 and event triggers 186 for first type of account 182. Execution proceeds to step 704 where management module 120 receives event information for first type of account 182. The event information may indicate that a particular type of event associated with account 182 has occurred. At step 706, management module 120 determines whether the event comprises one or more event triggers 186. For example, if an event trigger 186 relates to an age qualification of eighteen years old, and the account holder reaches the age of eighteen, then management module 120 may determine that an event occurred that comprises one of the event triggers 186. If not, then execution terminates at step 714. If so, execution proceeds to step 708 where management module 120 determines whether the second type of account 188 is pre-authorized. In particular, account manager 5b may have pre-authorized the activation of one or more types of accounts 188 when the first type of account 182 was initially established. For example, a parent of an account-holder may have pre-authorized the activation of a checking account 188 upon the teen account holder reaching the age of eighteen.

If the second type of account 188 is pre-authorized, as determined at step 708, then execution proceeds to step 712. If not, then execution proceeds to step 710 where management 120 requests and receives authorization for the second type of account 188 from account manager 5b. This may occur by sending an electronic request to account manager 5b, and receiving an electronic acknowledgement from account manager 5b authorizing the activation of the second type of account 188. Execution proceeds to step 712, where management module 120 activates second type of account 188. Management module 120 uses the account information 184, such as the name, address, social security information, account balance information, and the like to automatically initiate the activation of the second type of account 188. In this regard, the account-holder does not necessarily need to fill out forms with the financial institution that are normally associated with opening and activating an account.

Although method 700 is illustrated and described as initiating one second type of account 188 based on account information 184 associated with first type of account 182, it should be understood that activation of additional accounts 188 may be performed in the same or similar manner. For example, if first type of account 182 comprises a savings account, and a second type of account 188 is activated upon the account holder turning the age of sixteen, then still another type of account 188 may be activated based on the occurrence of another event. In particular, after the account holder graduates from high-school, then management module 120 may determine that an event trigger 186 has been met and subsequently initiate the activation of another type of account 188, such as an credit card account. In this regard, management module 120 may initiate the activation of any number and combination of accounts 188 using previously maintained account information 184 associated with existing accounts held by a particular account holder during the lifespan of the account holder.

FIG. 8 shows a user 5, computer systems 10, and a network 30 according to one example embodiment. In this example embodiment, users 5 may interact with one or more computer systems 10, and computer systems 10 may communicate with each other across network 30.

Users 5 may include any individual, group of individuals, entity, machine, and/or mechanism that interacts with computer systems 10. Examples of users 5 include, but are not limited to, a teenager, parent, customer, manager, executive, review board, accountant, engineer, technician, contractor, agent, and/or employee. Users 5 may be associated with an organization. An organization may include any social arrangement that pursues collective goals. One example of an organization is a family. Another example of an organization is a business. A business is an organization that provides goods or services, or both, to consumers, governmental entities, and/or other businesses.

Computer system 10 may include processors 12, input/output devices 14, communications links 16, and memory 18. In other embodiments, computer system 10 may include more, less, or other components. Computer system 10 may be operable to perform one or more operations of various embodiments. Although the embodiment shown provides one example of computer system 10 that may be used with other embodiments, such other embodiments may utilize computers other than computer system 10. Additionally, embodiments may also employ multiple computer systems 10 or other computers networked together in one or more public and/or private computer networks, such as one or more networks 30.

Processors 12 represent devices operable to execute logic contained within a medium. Examples of processor 12 include one or more microprocessors, one or more applications, and/or other logic. Computer system 10 may include one or multiple processors 12.

Input/output devices 14 may include any device or interface operable to enable communication between computer system 10 and external components, including communication with a user or another system. Example input/output devices 14 may include, but are not limited to, a mouse, keyboard, display, and printer.

Network interfaces 16 are operable to facilitate communication between computer system 10 and another element of a network, such as other computer systems 10. Network interfaces 16 may connect to any number and combination of wireline and/or wireless networks suitable for data transmission, including transmission of communications. Network interfaces 16 may, for example, communicate audio and/or video signals, messages, Internet Protocol packets, frame relay frames, asynchronous transfer mode cells, and/or other suitable data between network addresses. Network interfaces 16 connect to a computer network or a variety of other communicative platforms including, but not limited to, a public switched telephone network (PSTN); a public or private data network; one or more intranets; a local area network (LAN); a metropolitan area network (MAN); a wide area network (WAN); a wireline or wireless network; a local, regional, or global communication network; an optical network; a satellite network; a cellular network; an enterprise intranet; all or a portion of the Internet; other suitable network interfaces; or any combination of the preceding.

Memory 18 represents any suitable storage mechanism and may store any data for use by computer system 10. Memory 18 may comprise one or more tangible, computer-readable, and/or computer-executable storage medium. Examples of memory 18 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

In some embodiments, memory 18 stores logic 20. Logic 20 facilitates operation of computer system 10. Logic 20 may include hardware, software, and/or other logic. Logic 20 may be encoded in one or more tangible, non-transitory media and may perform operations when executed by a computer. Logic 20 may include a computer program, software, computer executable instructions, and/or instructions capable of being executed by computer system 10. Example logic 20 may include any of the well-known OS2, UNIX, Mac-OS, Linux, and Windows Operating Systems or other operating systems. In particular embodiments, the operations of the embodiments may be performed by one or more computer readable media storing, embodied with, and/or encoded with a computer program and/or having a stored and/or an encoded computer program. Logic 20 may also be embedded within any other suitable medium without departing from the scope of the invention.

Various communications between computers 10 or components of computers 10 may occur across a network, such as network 30. Network 30 may represent any number and combination of wireline and/or wireless networks suitable for data transmission. Network 30 may, for example, communicate Internet Protocol packets, frame relay frames, asynchronous transfer mode cells, and/or other suitable data between network addresses. Network 30 may include a public or private data network; one or more intranets; a local area network (LAN); a metropolitan area network (MAN); a wide area network (WAN); a wireline or wireless network; a local, regional, or global communication network; an optical network; a satellite network; a cellular network; an enterprise intranet; all or a portion of the Internet; other suitable communication links; or any combination of the preceding. Although the illustrated embodiment shows one network 30, teachings of certain embodiments recognize that more or fewer networks may be used and that not all elements may communicate via a network. Teachings of certain embodiments also recognize that communications over a network is one example of a mechanism for communicating between parties, and any suitable mechanism may be used.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order. Additionally, operations of the systems and apparatuses may be performed using any suitable logic. As used in this document, “each” refers to each member of a set or each member of a subset of a set.

Although several embodiments have been illustrated and described in detail, it will be recognized that substitutions and alterations are possible without departing from the spirit and scope of the present invention, as defined by the appended claims.

To aid the Patent Office, and any readers of any patent issued on this application in interpreting the claims appended hereto, applicants wish to note that they do not intend any of the appended claims to invoke paragraph 6 of 35 U.S.C. §112 as it exists on the date of filing hereof unless the words “means for” or “step for” are explicitly used in the particular claim.

What is claimed is:

1. A deposit system for receiving funds into an account held for an account beneficiary, the account being identifiable by an account number, the deposit system comprising:
a management module operable to register a plurality of contributors;
a contributor module operable to:
receive information identifying a first contributor;
determine whether the first contributor is one of the plurality of registered contributors; and
if the first contributor is a registered contributor, receive, from the first contributor, a deposit of funds, the deposit comprising a first set of funds associated by the first contributor for deposit into the account without identifying the account by the account number; and
an allocation module operable to deposit the first set of funds into the account without informing the first contributor of the account number.

2. The deposit system of claim 1, wherein the contributor module is further operable to:
receive, from the first contributor, a personalized message associated with the deposit of funds; and
deliver the personalized message to the account beneficiary.

3. The deposit system of claim 2, wherein the contributor module is further operable to:
provide a menu of personalized messages; and
receive, from the first contributor, a selection of the personalized message from the menu of personalized messages.

4. The deposit system of claim 1, wherein the contributor module is further operable to receive instructions, from the first contributor, specifying when the allocation module is authorized to deposit the first set of funds into the account.

5. The deposit system of claim 1, wherein the deposit further comprises a second set of funds associated by the first contributor for deposit into the account after the first set of funds is deposited.

6. The deposit system of claim 1, wherein the management module is further operable to:
define a plurality of account categories within the account; and
associate each account category of the plurality of account categories for a unique purpose, each purpose restricting use of funds in its associated account category, wherein the deposit received from the first contributor associates an account category of the plurality of account categories to receive the first set of funds.

7. The deposit system of claim 1, wherein the first contributor is prohibited from withdrawing funds from the account.

8. A system comprising:
a memory operable to store information identifying a plurality of registered contributors; and
a processor coupled to the memory, the memory including executable instructions that upon execution cause the system to:
receive information identifying a first contributor;
determine whether the first contributor is one of the plurality of registered contributors;
if the first contributor is a registered contributor, receive, from the first contributor, a deposit of funds, the deposit comprising a first set of funds associated by the first contributor for deposit into an account held for an account beneficiary, the account being identifiable by an account number, wherein the first set of funds is deposited into the account without identifying the account number to the first contributor; and
deposit the first set of funds into the account without informing the first contributor of the account number.

9. The system of claim 8, the memory further comprising instructions that upon execution cause the system to:
receive, from the first contributor, a personalized message associated with the deposit of funds; and
deliver the personalized message to the account beneficiary.

10. The system of claim 9, the memory further comprising instructions that upon execution cause the system to:
provide a menu of personalized messages; and
receive, from the first contributor, a selection of the personalized message from the menu of personalized messages.

11. The system of claim 8, the memory further comprising instructions that upon execution cause the system to receive instructions, from the first contributor, specifying when the first set of funds may be deposited into the account.

12. The system of claim 8, wherein the deposit further comprises a second set of funds associated by the first contributor for deposit into the account after the first set of funds is deposited.

13. The system of claim 8, the memory further comprising instructions that upon execution cause the system to:
define a plurality of account categories within the account; and
associate each account category of the plurality of account categories for a unique purpose, each purpose restricting use of funds in its associated account category, wherein the deposit received from the first contributor associates an account category of the plurality of account categories to receive the first set of funds.

14. The system of claim 8, wherein the first contributor is prohibited from withdrawing funds from the account.

15. A computerized method for receiving funds into an account held for an account beneficiary, the account being identifiable by an account number, the method comprising:
registering a plurality of contributors;
receiving information identifying a first contributor;
determining whether the first contributor is one of the plurality of registered contributors;
if the first contributor is a registered contributor, receiving, from the first contributor, a deposit of funds, the deposit comprising a first set of funds associated by the first contributor for deposit into the account without identifying the account by the account number to the first contributor; and
depositing the first set of funds into the account without informing the first contributor of the account number.

16. The computerized method of claim 15, further comprising:
receiving, from the first contributor, a personalized message associated with the deposit of funds; and
delivering the personalized message to the account beneficiary.

17. The computerized method of claim 16, further comprising:
providing a menu of personalized messages; and
receiving, from the first contributor, a selection of the personalized message from the menu of personalized messages.

18. The computerized method of claim 15, further comprising receiving instructions, from the first contributor, specifying when the first set of funds may be deposited into the account.

19. The computerized method of claim 15, wherein the deposit further comprises a second set of funds associated by the first contributor for deposit into the account after the first set of funds is deposited.

20. The computerized method of claim 15, further comprising:
defining a plurality of account categories within the account; and
associating each account category of the plurality of account categories for a unique purpose, each purpose restricting use of funds in its associated account category, wherein the deposit received from the first contributor associates an account category of the plurality of account categories to receive the first set of funds.
